(19) United States
(12) Patent Application Publication
(10) Pub. No.: US 2026/0155889 A1
(43) Pub. Date: Jun. 4, 2026

(54) CURRENT DENSITY ADAPTATION FOR AN OPTICAL WIRELESS COMMUNICATION SYSTEM

(71) Applicant: SIGNIFY HOLDING B.V., EINDHOVEN (NL)

(72) Inventor: JOHAN PAUL MARIE GERARD LINNARTZ, EINDHOVEN (NL)

(21) Appl. No.: 18/706,778

(22) PCT Filed: Nov. 7, 2022
(86) PCT No.: PCT/EP2022/080911

§ 371 Date: May 2, 2024

(30) Foreign Application Priority Data
Nov. 9, 2021 (EP) 21207133.6

(51) Int. Cl. H04B 10/116; H04B 10/114

(52) U.S. Cl. CPC H04B 10/116; H04B 10/1141

(57) ABSTRACT

This invention relates to an optical wireless communication system that adapts current density of a light source depending on the link demands. To control current density independently of total current, a light emitting diode (LED) is used that allows adaption of the surface area of the active part of the junction or quantum well through which the current is sent. In an example, the total current is a constant and determined by the allowed power consumption, but nonetheless multiple LEDs are mounted. The current can be adaptively divided among the LEDs, where for short range communication a single LED is used (at high current, high bandwidth, lower efficiency), while for longer-range communication, more LEDs, thus lower current density (thus higher efficiency) are used, or where a selection is done among a fast operating mode with two active LEDs for short distance, a medium operation mode with one active LED with higher current density, and a slow operating mode with one active LED with lower current density for long distance.

### FIELD OF THE INVENTION

The invention relates to the field of signal transmission in optical communication networks, such as—but not limited to—LiFi networks, for use in various different applications for home, office, retail, hospitality and industry.

### BACKGROUND OF THE INVENTION

Wireless communication via light is rapidly gaining interest. Optical wireless communication (OWC) systems, such as LiFi networks (named like WiFi networks), enable mobile user devices (called end points (EP) in the following) like laptops, tablets, smartphones or the like to connect wirelessly to the internet. WiFi achieves this using radio frequencies, but LiFi achieves this using the light spectrum which can enable unprecedented data transfer speed and bandwidth. Furthermore, it can be used in areas susceptible to electromagnetic interference. An important point to consider is that wireless data is required for more than just our traditional connected devices. Today, televisions, speakers, headphones, printer's, virtual reality (VR) goggles and even refrigerators use wireless data to connect and perform essential communications. Radio frequency (RF) technology like WiFi is running out of spectrum to support this digital revolution and LiFi can help power the next generation of immersive connectivity.

Based on modulations, information in the coded light can be detected using any suitable light sensor. This can be a dedicated photocell (point detector), an array of photocells possibly with a lens, reflector, phosphorous diffuser etc., or a camera comprising an array of photocells (pixels) and a lens for forming an image on the array. E.g., the light sensor may be a dedicated photocell included in a dongle which plugs into the end point, or the sensor may be a general purpose (visible or infrared light) sensor of the end point having sufficient bandwidth or an infrared detector initially designed for instance for 3D face recognition. Either way this may enable an application running on the end point to receive data via the light.

United States patent application US 2013/0272716 A1 for example discloses an illumination device for embedding data symbols of a data signal in the luminance output of the illumination device. More specifically it proposes to use an unmodulated conventional LED driver providing an unmodulated current which is fed to an LED. The LED having two LED segments having a common electrode. In addition a controller is provided to pass the unmodulated drive current through either a signle segment or both segments in a data dependent manner. The luminous output of the LED is the combination of the luminous output of the two segments, in this manner it is possible to modulate the luminous light output without modulating the drive signal supplied to the common electrode.

Optimization of light emitting diode (LED) design can be interesting to optimize performance. The design of an OWC communication system involves various complexities that do not have their counterpart in RF technology. Firstly, radio systems often need to operate in a given, limited bandwidth. Hence transmit power, pathloss and noise in the signal bandwidth determine the throughput. In contrast to this, the LED acts as a low pass filter but is not strictly limited in bandwidth. Hence the signal to noise ratio (SNR) is given by the transmit power available, pathloss and noise spectral power density, but also a choice of bandwidth which is a subject of optimization.

OWC systems need to communicate over a wide range of distances, while the available transmit power is limited. In many systems, maximum available power is already used, so that the total current is not supposed to grow beyond the limited power budget.

There exist several approaches to adapt the system to a change in reception power. One approach is to change the bit loading. Orthogonal Frequency Division Multiplexing (OFDM) is a popular modulation method in which the data is carried over many subcarriers in parallel. Many systems including the ITU G.9991, can adapt the signal constellation, i.e., the number of bits carried in one symbol or on one subcarrier. At good signal-to-noise ratio (SNR), high constellations, e.g., 256 QAM or above, are used, while at lower SNR the system falls back to lower constellations, e.g., 64, 16 or even only 4 QAM). When the SNR is low, for instance when longer ranges need to be covered, also the signal power can be increased.

To cover wider distances, one may want to increase the power. A first step in this direction can be to increase the modulation signal power. Yet, in many systems the current through the transmitting LED consists of an alternating current (AC) modulation component and a direct current (DC) bias component. Increasing the modulation signal power while keeping the DC bias constant can be an option to increase the received signal strength. However, this may increase distortion and clipping.

### SUMMARY OF THE INVENTION

It is an object of the present invention to provide an adaptive driving scheme for a semiconductor light source to cover a wide range of distances.

This object is achieved by an apparatus as claimed in claim 1, by an optical wireless communication device as claimed in claim 11, by an optical communication system as claimed in claim 12, by a method as claimed in claim 13, and by a computer program product as claimed in claim 15.

According to a first aspect, an apparatus is provided for driving a semiconductor radiation source having a radiation generating area of a controllable size, the apparatus comprising:
a modulator for supplying a driving signal to the semiconductor radiation source to modulate a current flowing through the radiation source; and
a controller configured to adaptively control the size of the radiation generating area independent from the current flowing through the radiation source, to change a current density and/or output power of the semiconductor radiation source in response to at least one of link performance requirement, measured link quality and distance to a receiver device.

According to a second aspect, a method of driving a semiconductor radiation source having a radiation generating area of a controllable size is provided, the method comprising:
supplying a driving signal to the semiconductor radiation source to modulate a current flowing through the radiation source; and
adaptively controlling the size of the radiation generating area independent from the current flowing through the radiation source, to change a current density and/or output power of the semiconductor radiation source in response to at least one of link performance requirement, measured link quality and distance to a receiver device.

Accordingly, given a certain available electrical power, there is freedom of choice in the current density or driving power at which individual radiation elements of the radiation source (e.g., one or more serial and/or parallel LEDs or other radiation elements) is operated. High current densities give the radiation source a wider bandwidth, but also make it less efficient in translating current modulation into a modulation of the optical output power. The operational point can be optimized so that high current densities are provided for short-range small-coverage systems to achieve very high throughputs, while radiation sources with wide beam angles (e.g., covering tens of square meters) are better off with lower current densities. Increasingly sectorized beams are used in which every beam has a limited, but principally non-zero diverge angle. In any case, even for such narrower beams, with limited divergence, the light intensity tends to decrease with the square of distance, such that distance-dependent control is favourable.

Preferably, the modulator modulates the driving signal based on the input data and supplies the modulated driving signal to the semiconductor radiation source, the data is thus embedded in the drive signal provided to the radiation source, independent from the data and the current flowing through the radiation source, the controller then adaptively controls the size of the radiation generating area in response to at least one criterion, such as a link performance requirement, a measured link quality and a distance to a receiver device. As a result the current density and/or the optical output power of the radiation source can be varied on a need to basis based on the criterion.

The radiation source can thus be designed with a light generating area of variable size (e.g., by placing more than one radiation element (e.g., LED) in parallel or otherwise providing a configurable or scalable light generating area), such that the junction area that can be interpreted as the effective area can be increased or decreased. The direction of the emissions of the configurable or scalable light generating area will be (substantially) the same, and when using multiple radiation elements, all radiation elements may be driven using the same data signal (although separate drivers may be used when different LED types are used), the proposed variation is in the size of the light generating area and not the emission beam width. Alternatively, one may electrically place multiple LEDs in series and shunt-out one or more but not all LEDs. Such scheme may require a control mechanism to also adapt the current, to avoid that the total power consumption becomes proportional to the number of active LEDs. As another option, the junction area of the radiation source could be decreased by switching off one or more micro-LEDs out of a set of micro-LEDS with very small sizes, thus increasing the current density(ies) for the remaining micro-LEDs (and the reverse for increasing the junction area). Alternatively, one may use two (sets of) LEDs with quite different current densities. Micro-LED use large current densities (low efficiency; high bandwidth), while normal LED have lower current densities. It is attractive to be able to switch between a normal LED (for large range) and a micro-LED based emitter (for short-range or narrow beam high speed). As micro-LEDs mostly operate at lower currents, preferable either multiple micro-LEDs are used or one normal LED, adaptively.

In an example, the selected subset of LEDs may be between 1 and N, where N can be larger than 20. If a combination of micro-LEDs and normal LEDs is used, one micro-LED and one normal LED may result in a ratio of light emitting areas or current densities, that is >>10.

It is noted that the proposed driving scheme also works well for transmission over optical fibers (e.g. polymer optical fibers (POFs)) which allow small and thus fast detectors and where transmitter limitations are relevant. Thereby, higher bit rates can be achieved for semiconductor light sources (e.g. LEDs) over optical fibers as well.

According to a third aspect, an optical wireless communications device, such as an optical wireless access point or end point, is provided for a radiation signal for an optical communication system, wherein the optical wireless communication device, for example, an access point or an end point comprises an apparatus according to the first aspect and a semiconductor radiation source having a radiation generating area of a controllable size.

According to a fourth aspect, an optical communication system comprising an optical wireless communication device (e.g., access point or end point) according to the third aspect and a receiver for receiving the radiation signal is provided.

According to a fifth aspect, a computer program product is provided, which comprises code means for producing the steps of the above method of the second aspect when run on a controller device.

According to a first option of any of the first to fifth aspects, the size of the radiation generating area may be controlled (e.g., by the controller) by selecting a subset out of multiple LEDs of the radiation source. Thus, the proposed current density or total power control can be achieved by simply switching on and off different LEDs (e.g., LEDs with different characteristics, or different ones with the same characteristics) through which a total current of the radiation source is passed.

According to a second option of any of the first to fifth aspects, which can be combined with the first option, the size of the radiation generating area may be controlled (e.g., by the controller) by causing a switch between using either one or two LEDs of the radiation source. This option provides a simple solution with two identical or different LEDs.

According to a third option of any of the first to fifth aspects, which can be combined with the first or second option, transmission from the radiation source may be controlled (e.g., by the controller) so that data packets are alternatingly transmitted via a different LED. This embodiment lends itself to applications where the LEDs used are of the same type, and preferably selected based on matching characteristics. Thereby, power loss and temperature can be reduced by decreasing the on-times of the LEDs.

According to a fourth option of any of the first to fifth aspects, which can be combined with any one of the first to third options, the current flowing through the radiation source may be controlled (e.g., by the controller) as a separate parameter. This provides the advantage that two separate control options for adapting transmission parameters to link performance requirements and/or link properties and/or distance can be provided.

According to a fifth option of any of the first to fifth aspects, which can be combined with any one of the first to fourth options, the radiation source may be operated (e.g., by the controller) at a selected current density while different operating modes of the radiation source may be switched (e.g., by the controller). Thereby, a more flexible control for adapting transmission parameters to link performance requirements and/or link properties and/or distance can be provided.

According to a sixth option of any of the first to fifth aspects, which can be combined with any one of the first to fifth options, the current density of the radiation source and at least one modulation parameter of the modulator may be controlled (e.g., by the controller) to achieve a trade-off between a degree to which transmission link is limited by noise and a degree to which the transmission link is limited by bandwidth. Thereby, link quality can be jointly optimized in two different dimensions.

According to a seventh option of any of the first to fifth aspects, which can be combined with any one of the first to sixth options, the modulator may be configured to modulate the driving signal supplied to the radiation source with a binary data sequence to generate at least two levels of a driving current through the radiation source that define a radiation output range of the radiation source between an upper radiation output level and a lower radiation output level during transmission of the binary data sequence. In case of a 2-level PAM modulation, the two driving current levels may for example be a maximum or a nominal drive current level for driving the high-level on the one hand and the zero current level on the other hand for driving the low-level. According to the seventh option, the controller may be configured to adaptively control the modulator to increase the driving current and switch the increased driving current at a timing determined by a reduced radiation output range between a predetermined upper target level and a predetermined lower target level in response to a transmission quality of the radiation output. These measures provide the advantage that in case of a (short-range) link where the received signal strength is adequate, a favorable lower radiation output swing between the “zero” and “one” can be set to increase the available transmission speed, using the same drive current levels as used for the full higher radiation output swing. As the reduced radiation output range is a subrange of the radiation output range and the amplitude of the driving signals is kept the same, but the timing is changed, it will be possible to traverse the lower radiation output swing in a faster manner, thereby facilitating higher speed transmissions, when the link quality allows.

The seventh option is preferably combined with driving the LED into droop to achieve higher bandwidths. Thereby, an optimization of transmission efficiency can be achieved by combining droop and elevation of zero level. Moreover, pre-emphasis could be introduced for further optimization.

According to an eighth option of any of the first to fifth aspects, which can be combined with any one of the first to seventh options, a look-up table that stores a table of modulation parameters (e.g., symbol rate) and current-density determining parameters associated with different channel attenuation conditions may be provided. Thereby, fast and efficient current density control by simple memory look-up can be provided.

According to a ninth option of any of the first to fifth aspects, which can be combined with any one of the first to eighth options, a receiver may be configured to provide a feedback information via a feedback channel to inform the controller about a link quality, or to command the controller via the feedback channel using the feedback information to change its current density setting. Thus, a feedback loop via the receiver can be provided for enhanced current density control.

According to a tenth option of any of the first to fifth aspects, which can be combined with any one of the first to ninth options, a selection may be provided (e.g., by the controller) among a fast operating mode of the radiation source with two active LEDs for short distance, a medium operation mode of the radiation source with one active LED with higher current density, and a slow operating mode of the radiation source with one active LED with lower current density for long distance. Thus, current density can be controlled by simply switching between different operating modes that involve different types of LEDs.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the optical wireless communication device of claim 11, the optical communication system of claim 12, the method of claim 13, and the computer program product of claim 15 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of an optical communication system according to various embodiments;

FIG. 2 shows a characteristic diagram of external quantum efficiency and light generation vs. current density;

FIG. 3 shows a characteristic diagram of external quantum efficiency vs. bandwidth;

FIG. 4 shows schematically a block diagram of inter-symbol interference detection at a transmitter of an embodiment;

FIG. 5 shows schematically a functional block diagram of inter-symbol interference detection at a receiver of an embodiment;

FIG. 6 shows schematically a circuit diagram of a transmitter with switched LEDs according to an embodiment;

FIG. 7 shows a flow diagram of a current density control procedure for a transmitter with LED mode selection; and

FIG. 8 shows schematically in two diagrams a first radiation output range and accompanying timing and second radiation output range and accompanying timing.

### DETAILED DESCRIPTION OF EMBODIMENTS

Various embodiments of the present invention are now described based on an optical wireless illumination and communication (LiFi) system with adaptive current density control. Although the present invention is particularly advantageous within the context of an illumination system, the invention is not limited thereto and may also be used within an optical wireless communication system that is not integrated within an illumination system. Instead, it may be used in a dedicated optical wireless communication system or within a fiber-based optical communication system.

Throughout the following, a light source may be understood as a radiation source that generates visible or non-visible light (i.e., including infrared (IR) or ultraviolet (UV)) light sources) for communication purposes. The light source may be included in a luminaire, such as a recessed or surface-mounted incandescent, fluorescent or other electric-discharge luminaires. Luminaires can also be of the non-traditional type, such as fiber optics with the light source at one location and the fiber core or “light pipe” at another. The concepts can also be used in peer-to-peer communication between smartphones or Internet of Things (IoT) devices.

It is further noted that when using optical wireless communication based on invisible parts of the light spectrum, such as infrared and/or or ultraviolet, the system can be fully decoupled from any illumination systems. In such scenarios the optical wireless communications systems may function to primarily provide communication and a separate transceiver node may be used in the optical wireless communication system. Alternatively, such optical wireless communication systems may be complementary to a further function and thus be integrated in other application devices that benefit from such communication functionality; such as personal computers, personal digital assistants, tablet computers, mobile phones, televisions, etc.

Conventional light source luminaires are rapidly being replaced by light emitting diode (LED) based lighting solutions. In LiFi systems, more advanced LED-based luminaires are enabled to act as LiFi communications hub to add LiFi connectivity to lighting infrastructure. The underlying idea is that an illumination infrastructure is positioned in such a manner that it provides a line of sight from the luminaire to locations where people tend to reside. As a result, the illumination infrastructure is also well positioned to provide optical wireless communication that likewise requires line of sight.

Adaptive LiFi systems using LEDs for optical wireless communications need to communicate over a range of distances, while the available transmit power is limited. For LEDs, the bandwidth of the LED and the efficiency at which currents are converted to light play a large role in the performance of the communication link. Both parameters are a function of the current density through the LED. More specifically, a trade-off exists between bandwidth and “power” that an LED can deliver.

So-called “microLEDs”, also known as micro-LED, mLED or uLED, is an emerging flat-panel display technology. Along with organic LEDs (OLEDs), microLEDs are aimed at small, low-energy devices such as AR glasses, VR headsets, smartwatches and smartphones. OLEDs and microLEDs both offer greatly reduced energy requirements. The inorganic nature of microLEDs gives them a longer lifetime advantage over OLEDs. These have far higher current densities and thus wider bandwidths.

A larger current density improves the bandwidth but reduces efficiency, which may be an appropriate choice for high-rate communication over a short distance. For longer ranges, lower current densities may be preferred to ensure that enough power is received, while the bandwidth can better be compromised if more power can be delivered. To cover larger distances at reasonable bandwidths, a further measure could be to increase the bias current. With a normal operation of an LED with a fixed die area, higher current implies a higher current density through the die area. This leads to more power but at a lower efficiency.

A system is therefore proposed to adaptively increase the light generating area of an LED transmitter (e.g., by using more LEDs) when longer range needs to be covered to jointly create not only a more powerful beam but also to maintain efficiency. Furthermore, by adjusting the total current and the current density independently of each other, it can be ensured that the system operates just with its maximum available power budget.

In an example, when the system needs to keep the total power fixed irrespective of the link distance and communication over a short range is desired, a larger current density through the LED transmitter can be applied, compared to the current density used for communication at longer range. To keep the total power fixed, the LED die area can be decreased when communicating over a short distance. As a result, a reduced efficiency is tolerated, as shorter distances incur lower path losses, while the benefit of a wider LED bandwidth due to a higher current density is achieved.

FIG. 1 shows schematically a block diagram of an optical communication system according to various embodiments.

It is noted that—throughout the present disclosure—only those structural elements and functions are shown, which are useful to understand the embodiments. Other structural elements and functions are omitted for brevity reasons.

The optical communication system of FIG. 1 may correspond to a communication link of a LiFi network that comprises a transmitter (optical emitter) 10 (e.g., an access point (AP) with a luminaire of a lighting system) connected via an optical channel (e.g., an optical free-space link) to a receiver (light detector) 20. A respective light output 100 (e.g., light beam) generated by a light source (LS) 12 of the transmitter 10 is received by a photo detector (PD) 22 of the receiver 20. The light source 12 may comprise one or more radiation emitting elements (e.g., LEDs) with a controllable active light generating area (LGA) 120 and the photo detector 22 may comprise a radiation detecting element (not shown).

An effective area of the active light generating area 120 can be changed by a current density controller (CDC) 18 such that the current density of the radiation emitting element(s) can be changed via a current density control output (CD) of the controller 18 while the total current through the light source 12 can be controlled (or kept constant) by total current control output (TC) of the controller 18 as a separate parameter.

In an embodiment, the controller 18 is thus configured to control the current density based on at least one of link performance requirements LPR and feedback information 200 (e.g., measured link properties or distance or commands).

The proposed adaptive optical wireless (e.g., LED) communication system of FIG. 1 is thus configured to be able to communicate over a range of distances, in which at shorter distances a wider bandwidth of the radiation emitting elements (e.g., LED(s)) of the light source 12 is achieved by using a higher current density while having a means (e.g., the controller 18) to separately control the total power consumption (e.g., by reducing the die area of the radiation emitting element (e.g., LED)) that is used at shorter distances.

In an example, the communication system may consist of the transmitter 10 with one or more radiation emitting elements (e.g., LEDs), a means (e.g., controller 18) to adapt the current density, and the receiver 20 as a cooperating receiver.

The receiver 20 may be configured to provide the feedback information 200 via a feedback channel to inform the transmitter 10 about e.g., a link quality such that the transmitter 10 can optimize the communication by selecting a better parameter setting.

Alternatively, the receiver 20 may calculate or estimate a better transmitter setting and may command the transmitter 10 via the feedback channel using the feedback information to change its operational setting(s), e.g., its current density setting.

As a further option, the transmitter 10 may select a current density based on a measurement of the distance to the receiver 20 performed by distance measurement function (DM) 15 provided at the transmitter 10 (e.g., at the controller 18), and thereby executes current density control autonomously. The distance measurement may be based on an passive and active measurement, such as a geometrical measurement, a time-of-flight (TOF) measurement, interferometry-based measurement, etc.). Alternatively, the distance measurement function 15 of the transmitter 10 may uses parameter(s) in the reverse link e.g. via the feedback channel to derive the distance (and/or an angular attenuation associated with not being in the center of the beam) and/or other propagation attenuations, to optimize its own light source (e.g., LED) parameter setting (e.g., rate and current density).

As a further option, a hybrid, implicit feedback approach can be used, where the transmitter 10 may further take advantage of the understanding that the communication partner station (e.g., the receiver 20) in its turn selects for the reverse link its settings (e.g., current density, thus output power efficiency and bit rate) based on the signal that it receives from the forward link.

In an example, the communication system may be configured to measure at least two aspects of the link quality. A first aspect relates to the degree to which the link is limited by noise, such as the SNR, and a second aspect relates to the degree to which the link is limited by the bandwidth, such as inter symbol interference (ISI). An optimization control (e.g., by the controller 18) can then be used to achieve a trade-off between these two limitations, e.g., by adapting current density (or die area) by the current density control output CD and by adapting modulation parameters (e.g., bit rate etc.) by a modulation parameter control output MP supplied to a modulator (MOD) 14 of the transmitter 10.

Alternatively, the selection of the current density can be based on a simple criterion such as a measurement of the distance (e.g., by the distance measurement function 15), or an error rate (e.g., block error rate (BER)) or SNR. A look-up table (LUT) can be used to connect the chosen current density and the modulation parameters based on a selected criterion. In an example, the LUT may store modulation parameters and current-density determining parameters associated with different channel attenuation conditions. Suitable modulation parameters may be e.g. bit or symbol rate and/or constellation size (i.e., the number of levels per symbol or the number of bits per symbol). In an OFDM system, these modulation parameters may be chosen for every subcarrier. In OFDM, also the modulation power per subcarrier can be selected, e.g., within a constrained budget.

The LUT may contain all these parameters, where one combination is taken based on the selected criterion.

The above single measurement approach may require a calibration between the used modulation parameters to match the value of the selected criterion, such that performance is maximized (e.g., highest bitrate (bit/s), lowest energy per bit etc.), but with a tolerance for system aging and deterioration in daily use. Therefore, an adaptive, self-optimizing approach may be preferred.

Additionally, the transmitter 10 comprises an encoder (ENC) 16 for encoding input data DI received via an interface circuit (not shown) to obtain a binary data sequence which consists of a sequence of binary values “0” and “1” according to a selected binary encoding scheme. The binary data sequency may be supplied to the modulator 14 (e.g., a switching circuit) to generate a driving signal (e.g., driving current or voltage) in accordance with a driving scheme and supply it to the light source 12 to generate the light output 100 e.g. with an on-off keying (OOK) or other keying-based modulation schemes or an OFDM modulation scheme, such as e.g. DCO-OFDM, ACO-OFDM or Flip-OFDM.

In an advanced system, the controller 18 may combine the adaptation of current density with (adaptive) mechanisms to extend the signal bandwidth beyond the LED bandwidth, for instance with an adaptive pre-emphasis. It is thus not necessary that the bandwidth of the signal is limited to the bandwidth of the LED. In fact, transmitter and/or receiver methods may be provided to extend the modulation bandwidth beyond that of the LED, thereby compensating for possible ISI. These can be used in combination with the approach of varying current density.

One specific example is the use of a pre-emphasis, that boosts high frequencies in the LED modulator electronics hardware or by signal processing to compensate for the low-pass filtering introduced by the LED. Such high-frequency boost artificially extends the apparent LED bandwidth, thus it allows a wider signal bandwidth at the expense of a reduced power efficiency. Pre-emphasis, preferably an adaptively chosen pre-emphasis, can be used in combination with the approach of varying current density.

In a second example described later, 2-PAM can be applied in which the lower signal level is chosen to be above zero. This avoids complete depletion of the LED junction and thereby keeps the LED operating in a regime in which the response speed is high.

In a third more specific example, the controller 18 may be configured to apply an OOK scheme where an allowable maximum and minimum light output level or output light range for the light source 12 is determined based on a transmission quality information fed back from the receiver 20. E.g., when the transmission quality increases, the driving signal and thus the drive current can be switched at a higher rate (increased bit rate) to reduce the distance between maximum and minimum light output levels, or allowable maximum and minimum light output levels are set to be closer together so that the drive signal is switched at a higher rate (which may be called “accelerated” OOK).

Moreover, the light source 12 may be configured to provide a feedback signal that indicates the light output level or a property or parameter related to light level to the modulator 14, which uses the feedback signal together with the switching time/rate and/or maximum/minimum light level or light range to generate or control the driving signal and apply it to the light source 12. Based on the feedback signal, the control information and the modulation parameters, the modulator circuit 14 adjusts the driving signal to control the range and/or level of the driving current of the light source 12 and thus the light output 100 in accordance with the selected modulation scheme (e.g., accelerated OOK).

In an example, the modulator 14 (i.e., modulator driver) may act as a switching device that is controlled by the driving signal to switch the driving current through (or voltage across) the radiation emitting element(s) of the light source 12 between a number of discrete values (e.g. 2 or 4 discrete vales).

At the receiver 20, the output signal of the photo detector 22 may be supplied to a demodulator circuit (not shown) where it is demodulated by detecting or discriminating light output levels to obtain a binary data sequence. This binary data sequency may then be decoded in a decoder circuit (not shown) to obtain output data which should correspond to the original input data (i.e., original binary data sequence) DI supplied the transmitter 10. Then, a link quality determination circuit (LQD) 28 may check the output data based on an error detection scheme (e.g., parity checking, cyclic redundancy check (CRC), error correction coding etc.) to determine a transmission quality (e.g. SNR) of the optical transmission. The checking result may optionally be fed back as the feedback information (e.g., transmission quality information) 200 from the receiver 20 to the transmitter 10 via the feedback channel for use by the controller 18.

In an example, a control software may be running on a central processing unit (CPU) provided at the controller 18 and/or the receiver 20 to provide the controller and receiver functions discussed herein.

Being a semiconductor device (e.g., LED), the physical properties of the light source 12 modify the optical output 100 to become a low pass filtered version of the driving current. More specifically, a junction of a semiconductor light source is a capacitance and discharging of that capacitance by means of hole-electron pairs that recombine into photons is a nonlinear function of the charge. Particularly, when the capacitance is in a state of low charge, not many photons are created such that discharging gets slower and slower. If the symbol rate of the driving signal is faster than the 3 dB bandwidth of the light source 12, then ISI would occur without further measures. However, the switching time/rate (e.g., bit rate) of the light source 12, which corresponds to the time resolution of on-off switching, can be selected by the controller 18 to be faster than the symbol rate or to occur at other (later or earlier) instances than the bit transition. As a result, it can be facilitated that the optical output 100 reaches the light level target value at a sampling instant.

In the following, various examples of current density control for the light source 12 are described in more detail.

Experiments reveal that the power and bandwidth product of an LED is substantially constant if various parameters are varied. At least, the power and bandwidth seem to relate to each other as a trade-off, in which an increase of bandwidth leads to a decrease of the achievable power. Similarly, it can be shown from LED models that LED efficiency, for instance external quantum efficiency (EQE), and bandwidth are jointly constrained if various parameters are varied. In good approximation, the product of efficiency (raised to some exponent) and efficiency (possibly also raised to some exponent) is a constant. This trade-off may not be a fixed trade-off made during system design but may be made adaptive.

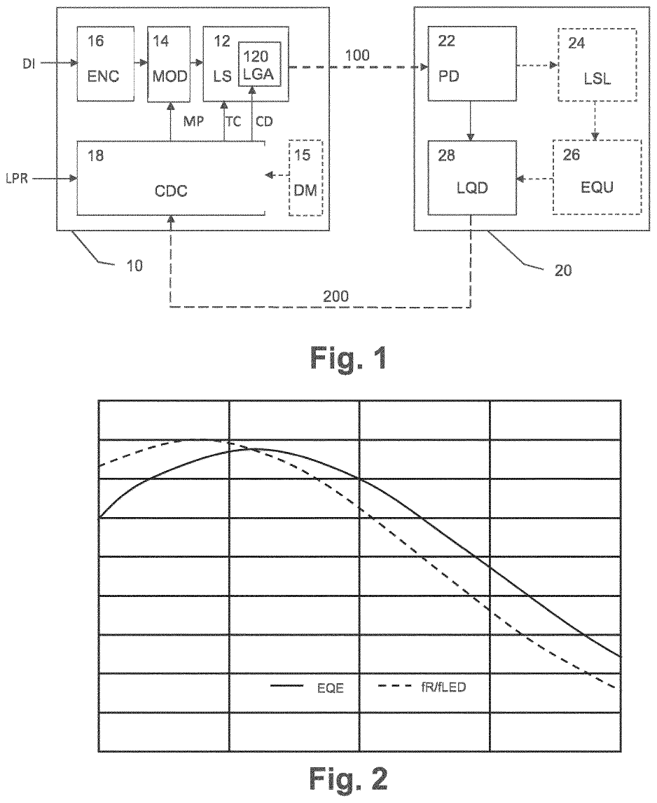

FIG. 2 shows a characteristic diagram of EQE and light generation (fR/fLED) vs. current density.

The ratio fR/fLED is a measure of the power efficiency, i.e., the ratio of optical output power over the total power that goes into the LED (also designated as differential EQE (dEQE=fR/fLED) as a particular derivative of quantum efficiencies). More specifically, fR is a measure of the radiative, photon-emitting recombination rate and fLED is a measure of the total recombination rate, including lossy recombination.

As can be gathered from FIG. 2, boosting the current (horizontal axis) may have a detrimental effect on EQE if one does not adequately cool the LED. EQE drops with current density due to the fact that DC light generation is less effective at higher current density.

EQE can thus be used for DC considerations and dEQE=fR/fLED can be used for modulation considerations. Furthermore, dEQE is a function of the LED current density and quantifies the efficiency at which a current modulation translates into an optical signal.

As a result, the fR/fLED curve of FIG. 2 is more relevant e.g. for OFDM type of modulation. It is valid for a “small” signal modulation on top of a DC bias.

Short-range small-coverage systems prefer high current densities to achieve very high throughputs. LiFi connections with wide opening angles, e.g., covering tens of square meters, can be operated more efficiently with a high dEQE, thus lower current densities.

More specifically, highly efficient OFDM modulation can be achieved at current densities that are close to and quite a bit smaller than the highest EQE, as shown in FIG. 2. Although high current density increases bandwidth but decreases efficiency, there is an optimum.

However, efficiency droop occurs when excited electrons overshoot nanometer-deep quantum wells in semiconductor material (such as GaN). The wells are designed to trap electrons into combining with holes. When electrons are too energetic to be trapped by the wells, they leak out of LED devices without emitting any light.

In view of the lack of experimental techniques capable of unambiguously identifying non-thermal droop mechanisms, arguments based on modeling and simulations become of primary importance. Here a simple and popular approach is based on the so-called “ABC-model” considering three principal channels of the electron and hole recombination in an active region of an LED. These are non-radiative Shockley-Read-Hall recombination, radiative recombination, and non-radiative Auger recombination. In particular, the ABC-model has been invoked to explain non-thermal droop in InGaN-based LED structures in terms of Auger recombination, being in good agreement with available observations. The ABC model appears to be suitable for a large class of LEDs, if not for all LEDs. However, the carrier concentrations may not be spatially constant and vary across the LED. In such case the LED may be seen as a device that incorporates many sub-LED volumes, each adhering to an ABC model, but each driven by a different carrier concentration. Nonetheless, mostly an average current density seems to model most LEDs well.

One more reason for the wide popularity of the ABC-model is its capability of excellent fitting the efficiency behavior of high-quality blue LEDs under variation of their operating current.

From the theory derived from the ABC model, the difference in efficiency is not very large if one compares the impact of a changing current density at a fixed temperature. When driving an LED deeper into droop, as is done to get higher bandwidths, the drop in output power efficiency is not extremely large (e.g., 10× difference leads to 50% reduction in power). However, if one considers that a higher current density heats up the junction, the effect tends to become more dramatic.

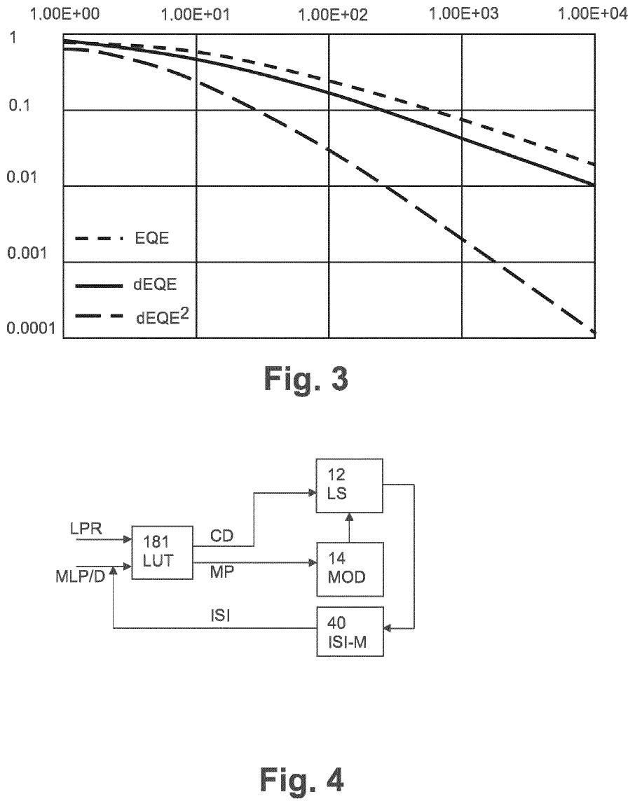

FIG. 3 shows a characteristic diagram of external quantum efficiency (EQE, dEQE and dEQE²) vs. bandwidth for a fixed temperature.

As can be gathered, power efficiency of an LED decreases with increased bandwidth, especially for “small” signal modulations (dEQE).

The trade-off between bandwidth and efficiency thus depends on the use case and may not have a generic answer. Nonetheless, it is interesting to study a reachable throughput for various LED settings for a specific class system configuration. More generically, one may desire to express channel capacity as a function of the current density. However, the channel is non-negative, frequency selective, non-linear and may be constrained both in optical and electrical power.

If one uses the same LED, uses a large range, but increase the current through one LED, the current density and the LED bandwidth increases, while the emitter efficiency d-EQE decreases. This has a lowering effect on the received signal strength. If range and coverage area are not a design concern, it may be attractive for a given available transmit power to increase the current density even to values where the LED becomes quite inefficient (low EQE, and low dEQE).

Thus, at very low SNR, the throughout is predominantly affected by dEQE, thus by how effectively the LED converts (slow) current variations in light variations. The response speed, thus the 3 dB bandwidth, only become relevant when more signal power is available.

These observations suggest that the illumination efficiency (i.e., EQE) is less relevant than the dEQE. However, for any practical small SNR, the operation point near the maximum EQE is a good choice, giving throughputs of tens of Mbit/s and allowing wide coverage, as long as the junction temperature can be considered to be constant irrespective of the current density.

The performance of a LiFI system is thus affected by the chosen operational point of the LED, in particular the current density. The optimum trade-off of how deeply the LED is to be driven into droop depends on the signal power and the required coverage.

As explained above, it is proposed to make sure that the system operates just around its maximum available power budget by adjusting the total current and the current density of the radiation emitting element(s) (e.g., LEDs) of the light source 12 of the transmitter 10 of FIG. 1 independently of each other.

In an embodiment, this change of die area may be achieved by selecting a subset out of multiple LEDs of the light source 12.

In an example, the current density control of the controller 18 may be achieved by causing a switch between using either one or two LEDs, thereby doubling the current density depending e.g. on the link distance or a link quality parameter. In practice, a larger ratio (e.g., 1:10) will be more effective. Nonetheless, if temperature effects that may occur at higher current densities need to be considered, a ratio of e.g. 1:2 (e.g., switching two identical LEDs) may already be effective.

The above considerations are supported by the well-known Shannon theorem:

$$R = B W log [ 1 + SNR ]$$

For short-range operation, where the SNR is relatively high, it is more effective to increase the bandwidth (BW) than to increase the SNR. The throughput grows linearly with bandwidth but only logarithmically with SNR. Even if one considers that the SNR drops if the bandwidth is increased and more noise it taken in, it is far more effective to increase the bandwidth than to boost the SNR.

A different approximation is needed for low SNR cases, where power and range are a concern. When bandwidth is not limiting compared to the SNR (i.e. P_{T}/(BW×N₀)→0), the throughput may be determined just by the SNR:

$$Rate = {lim}_{\frac{{P}_{T}}{BW {N}_{0}} \to 0} BW log [ 1 + \frac{{P}_{T}}{B W {N}_{0}} ] = constant \frac{{P}_{T}}{{N}_{0}}$$

In the above equation, P_{T} designates the transmission power and N₀ designates the noise level. Thus, the throughput (i.e., rate) is directly proportional to the SNR (P_{T}/N₀), so that error rate measurement can be used to evaluate the combined effect of SNR and bandwidth.

Optionally, a measurement of the difference between the incoming noise signal and reference levels in a level slicer (LSL) 24 of the receiver 20 in FIG. 1 can be used as an indicator of the combined effect of ISI and noise. The level slicer 24 is used to discriminate modulation levels (e.g., four levels in case of a PAM-4 modulation) and may be configured to shift a received signal based on an offset set for a respective slicer level, determine whether the shifted signal is greater than a threshold value and generate a number of comparison signals based on the determining, and generate multiple digital signals by demultiplexing the comparison signals.

A way to measure the ISI can be to use an (optional) equalizer (EQU) 26 provided in the receiver 20. The equalizer setting indicates whether or not a correction needed for ISI (thus a shortcoming in bandwidth) is excessive, such that it leads to an undesired noise enhancement. The equalizer 26 may be a simple equalizer that somewhat boosts high frequencies, approximately near the bandwidth roll-off of the LED. If such a filtered version gives a better signal, a larger bandwidth can be used (and thus a higher current density).

In an alternative example, the ISI may also be estimated at the transmitter 10.

FIG. 4 shows schematically a block diagram of an ISI detection at the transmitter 10 according to an embodiment.

The ISI can be determined by measuring to what extent the LED voltage follows the modulated current. That is, the (low-pass) effect of the capacitance of the LED in response to the modulation can be implicitly measured.

To achieve this, a look-up table (LUT) 181 or other addressable memory may be used (e.g., by the controller 18), that relates or associates a desired symbol rate or other link performance requirement LPR with its required bandwidth and required current density CD. The look-up table 181 may be provided with a temperature calibration for compensating any temperature-dependent effects.

Furthermore, an ISI measuring unit (ISI-M) 40 (which may be implemented by a routine or functionality of the controller 18) is configured to monitor the optical output 100 of the light source 12 and measure the ISI. This can be achieved by using sampling moments based on the modulating signal or by subtracting the optical output signal from the input currents of the light source (e.g., LED) to obtain an error signal that is representative for the ISI. The determined ISI can then be used as a further input parameter of the look-up table 181. Other input parameters for current density control may be other measured link parameters MLP and/or distance D.

As a further option, the look-up table 181 may store modulation parameters MP in association with input link performance requirements LPR, measured link properties MLP and/or distance, which can be used by the system (e.g., the controller 14) to control the modulating driving signal of the modulator 14.

Preferably, the system stores in the look-up table 181 a table of efficiencies and bandwidths for every current density that it can select between. The frequency response may be simplified as a first-order low-pass filter caused by the capacity of the light source (e.g., LED) 12. It may also be affected by other aspects, such as the electronics that drive the light source (e.g., LED) 12. Therefore, the look-up table 181 may comprise not only a single (3 dB or other characteristic) bandwidth, but a more complete frequency response of the transmission system.

The proposed system may be configured to operate at one particular current density of the light source (e.g., LED) 12 at any particular instant of time, e.g., under control of the controller 18, while it switches between operating modes of the light source 12. This nonetheless gives the system the opportunity to gather information about the SNR on every subcarrier if OFDM is used.

As the look-up table 181 can provide an estimate of the frequency response for the actual current density and also about potential alternative current densities, the system (e.g., the controller 18) can pre-calculate what the SNRs are on all subcarriers if another current density were chosen. Hence, it can compute how many bits every subcarrier can carry, thus also the total achievable throughput for alternative current densities. The system (e.g., the controller 18) then can select the best performing setting with the thus highest throughput.

Similarly, if PAM modulation is used without partitioning into subcarriers, the system (e.g., the controller 18) can determine deteriorations of the signal in the form of noise and in the form of ISI. The SNR can be improved by ensuring that the signal is stronger. In the normal operation regime beyond the highest-EQE point, the transmit efficiency of the light source (e.g., LED) 12 can be increased by reducing the current density but maintaining the total current. However, this comes at a cost of an increase of ISI caused by a smaller bandwidth. The system (e.g., the controller 18) may optimize the selection of the current through the light source (e.g., LED) 12, the symbol rate and the number of bits carried per symbol, to achieve the highest throughput (e.g., bits per second). It may also consider aspects of power consumption in such optimization, for instance to use the combination that gives the lowest energy consumed per bit transmitted (e.g., Joule per bit).

PAM systems may differ in the way that they handle ISI. In its simplest form, it lets ISI occur unequalized even though ISI may cause some bit errors. The proposed system of the present embodiments can work well with such a PAM system, because it ensures that ISI is not excessive at the transmitter 10 by adapting the bandwidth.

In an example, the proposed system (e.g., the controller 18) may select a symbol rate and a PAM size (e.g., number of levels, number of bits per symbol), that gives a just adequate error rate (i.e., one that is not excessively hampered by the ISI). In a simple form, the bit rate may be adapted by tracking of the error rate and the SNR, where the transmitter 10 takes care that the bandwidth is adequate for the desired symbol rate, for instance via the look-up table 181 or another control scheme described in other examples or embodiments. That choice also depends on the SNR. By adapting the current density, both the signal strength and the ISI are changed.

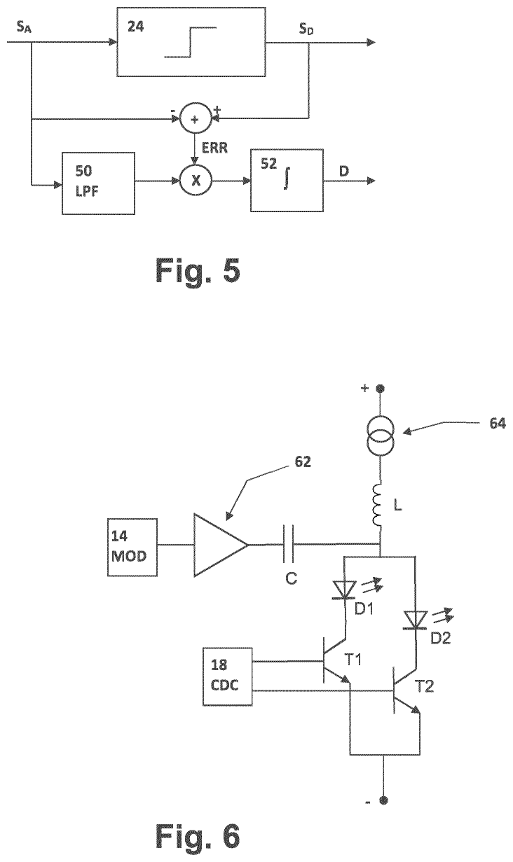

FIG. 5 shows schematically a functional block diagram of inter-symbol interference detection at a receiver according to an embodiment.

According to the functional block diagram of FIG. 5, an error ERR in a received digital signal S_{D} (that is the difference between the incoming analog signal SA and a digitized, quantized version of it after the level slicer 24 of FIG. 1) is correlated with a low-pass filtered version of the incoming analog signal SA as obtained at the output of a low pass filter (LPF) 50. If the error ERR correlates with the low-pass filtered signal (thus with previous bits), the ISI is expected to be significant. The correlator may not need a multiplier but may instead take the sign of the error ERR and the sign of the filtered signal and apply a logical XOR function/gate. The output of the multiplier or the XOR function/gate is then applied to an integrator or other low pass filter 52 to obtain an ISI detection output D.

The same driver or modulator 14 may be used in a single and multiple LED mode, where the modulation signal and the DC bias is split over two or more LEDs of the light source 12.

Alternatively, separate drivers may be used for each LED of the light source 12. Particularly if two different LEDs are used with more widely different properties, dedicated drivers or modulators 14 with optimized electronics can be used.

As another option, the LEDs of the light source 12 may be alternated in a single-LED mode. If these LEDs are identical, then data packets may be alternatingly transmitted via a different LED, so that the temperature can stay lower as each LED is less (intermittently) used. This improves the efficiency.

However, different LEDs of the light source 12 may react differently to temperature changes. In some LEDs, bandwidth may increase with temperature, while the bandwidth of other LEDs decreases with temperature. Observations have shown that, at least for some specific LEDs, the 3 dB bandwidth shrinks if the temperature increases. So, it can be useful to control the current density to increase the bandwidth, but to avoid that the temperature increases too much, as it deteriorates the efficiency and may reduce the bandwidth.

However, if high efficiency rather than high bandwidth is needed, two LEDs may be operated simultaneously at low current density, while if high bandwidth is needed, one LED may be used. Thus, a criterion is whether temperature is allowed to increase or needs to stay low for high bandwidth.

FIG. 6 shows schematically a circuit diagram of a transmitter with switched LEDs according to an embodiment.

The circuit diagram of FIG. 6 ensures that power consumption does not change significantly. In an example, the junction voltage of the LED may be about 2V for infrared (IR) emission or 3.5 V for blue-color emission. A fixed DC bias current is supplied by a current source 64 either to one or to two LEDs D1, D2.

The driver or modulator 14 supplies a modulating signal via an amplifier 62 and a coupling capacity C to the parallel circuit of the two LEDs D1, D2 to modulate the DC bias current, i.e., to add an AC modulation component to the DC bias component of the driving current. An additional inductance L is used for decoupling the current source 64 from the AC modulation component.

A switching controller (e.g., the controller 18) is used to control a switching state of respective switching transistors T1, T2 so as to individually switch on or off the two LEDs D1, D2.

In an operation mode where both LEDs D1 and D2 are switched on (active) via the respective switching transistors T1, T2, the efficiency and thus the output power of the light source is larger. This is favorable for communication over a larger range. In another operation mode where only one of the two LEDs D1, D2 is active, the activated LED receives a larger current, its efficiency drops, but its bandwidth is larger. This is favorable for short-range transmissions.

It is noted that the circuit of FIG. 6 can be used for other purposes (e.g., sectorization) in addition to control of the current density. For instance, the two LEDs D1, D2 may cover different sectors and the switch arrangement may select which sector to use. For instance, the light emission patterns of the two LEDs D1, D2 (or of the different selections of die area) may overlap, or the modulation (e.g., the bandwidth of the modulation) may change with the selection of the LEDs D1, D2, or the two LEDs D1, D2 may intentionally differ in their light generating area.

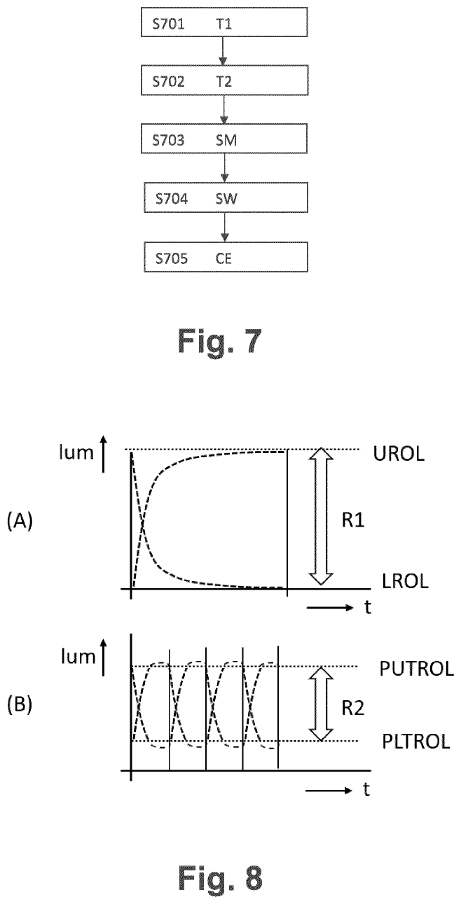

FIG. 7 shows a flow diagram of a current density control procedure for a transmitter with LED mode selection between a small number of settings (e.g., between using one or two LEDs).

In step S701, a first test (T1) is performed, where the transmission link is tested with a single LED of two identical LEDs. Then, in step S702, a second test (T2) of the transmission link is performed, where the driving current is spread over both LEDs.

In a subsequent mode selection (SM) step S703, the better performing operation mode (single or dual mode) is selected. If two different LEDs are used, three operating modes can be provided, which include a fast mode (short distance, both LEDs), a medium mode (one LED, using only the LED with the higher current density), and slow mode (long distance, using the other LED with lower current density).

Then, in a following switching (SW) step S704, the LEDs are switched according to the selected operating mode. In an example, the switching of the LEDs can be done at time instants in between two bursts of communication, e.g., between two data packets.

Finally, in an optional channel estimation (CE) step S705, a channel estimation (e.g., in OFDM systems) may be initiated or re-initiated after the current density settings have been changed.

In another example, the two selectable LEDs may comprise a microLED (having a very small light generating area and a high current density) and a mid or high power LED (having a large light generating area and a modest current density, preferably a current density that provides high efficiency).

In the above examples, the two LEDs may be driven by the same DC bias power supply, so that the selection is made to operate at approximately the same power but and trades range for bandwidth.

However, microLEDs often require higher bias voltages, or LEDs may be built as multiple junctions in series. In such case, maintaining the power requires different DC bias power supplies.

Anyhow, the common concept is to adjust current density and total current separately, where the adaptation of the total current may be subject to a power constraint, thus may be kept constant, despite the desire to change current density.

The ability to increase the current density promotes the use of LEDs with a tiny surface area. These may pose a higher risk to the human eye, because the light emitting surface can be projected in focus as a very small spot at the retina of the eye. At this spot, the local light intensity can be very large. To address this problem, optics may be configured to artificially expand the perceived surface area from which the light is emitted. An example can be a diffuser of an area that is larger than the surface area of the LED. In case of multiple LED areas, these may be shared by the same diffuser.

The diffuser may also be a micro-optical surface with many facets. This may be advantageous for cases where a narrower beam is desired, and a micro-optic structure can be used with beam shaping layers to direct the light into the desired beam direction.

In another example, collimating optics, preferably a total internal reflecting (TIR) structure may be used to shape the output beam and to simultaneously enlarge the perceived emitting surface area. These structures can be applied per LED, or for a composition of multiple LEDs in a switchable configuration.

In the following, examples for modulation optimizations that can be combined with the above embodiments and examples are described.

In an embodiment, the concept of changing the current density can be combined with a change in the setting of the modulation depth.

For a setting in which an increased symbol rate is facilitated by a higher current density, the current level used to transmit a logical “zero” can be lifted and set significantly above zero. A relatively high value of the low current avoids that the LED junction capacitance is depleted too far as the corresponding low carrier concentrations would bring the LED into a slow regime.

For OOK and PAM, an accelerated OOK can be used, where in case of a short-range link where the received signal strength is adequate, a lower swing between the “zero” and “one” current is favorable. In addition, following the ideas disclosed here, the current density may be increased as well by using an appropriately selected fraction of the total available die area. These measures provide the advantage that in case of a (short-range) link where the received signal strength is adequate, a favorable lower swing between the “zero” and “one” current can be set to increase the available transmission speed.

An example of a first radiation output range R1 and a second radiation output range R2 are provided in FIGS. 8A and 8B respectively. FIG. 8A shows that by application of a first drive current (for example a nominal or maximal drive current) the luminous output of the light source may be varied from the lower radiation output level LROL (for a “0” PAM-2 symbol) to the upper radiation output level UROL (for a “1” PAM-2 symbol). Likewise when starting at the upper radiation output level UROL the application of a second drive current (for example zero drive current) will result in the lower radiation output level. In comparison FIG. 8B shows that when the first and second drive currents are applied to vary the luminous light output between a predetermined upper target radiation output level PUTROL and a predetermined lower target radiation output level PLTROL, this results in the second radiation output range R2, being a proper subrange of the first radiation output range R1, the 2-level PAM symbols high and low level can be reached faster and therefore the data throughput can be increased, provided that the SNR at the receiver device would still allow proper decoding.

This can be advantageously combined with driving the LED into droop to achieve higher bandwidths. Thereby, an optimization of transmission efficiency can be achieved by combining droop and elevation of zero level. Moreover, pre-emphasis could be introduced for further optimization.

For OFDM, it is attractive to use a lower modulation depth for short-range links where ample signal strength is available. In such case, the distortion and LED non-linearity, rather than the noise may be a main limitation of the system. Keeping the same DC bias but reducing the modulation depth significantly reduces the distortion, though at the cost of a somewhat higher influence of the noise. This can allow high-constellation sizes (many bits per subcarrier).

On the other hand, for links of a longer range, the noise typically is the main limitation. If higher LED efficiency is important, a lower current density (less droop) may be preferred. In addition to having a higher current density for the DC bias, it can be advantageous to boost the modulation component. Although this may lead to a somewhat increased distortion, it provides the advantage of a stronger received signal that is less sensitive to noise.

According to various embodiments of the accelerated OOK scheme, an on-state of the driving current for switching on the light source can be made intentionally larger than the driving current that leads to a desired steady state light output. Additionally, an off-state of the driving current for switching off the light source 12 may not be a zero current (i.e. a disconnection of the driving current from the current source).

To summarize, an optical wireless communication system has been described, in which current density of a light source is adapted depending on the link demands. To control current density independently of total current, a light emitting diode (LED) can be used that allows adaption of the surface area of the active part of the junction or quantum well through which the current is sent. In an example, the total current is a constant and determined by the allowed power consumption, but nonetheless multiple LEDs are mounted. The current is adaptively divided among the LEDs, where for short range communication a single LED is used (at high current, high bandwidth, lower efficiency), while for longer-range communication, more LEDs, thus lower current density (thus higher efficiency) are used, or where a selection is done among a fast operating mode with two active LEDs for short distance, a medium operation mode with one active LED with higher current density, and a slow operating mode with one active LED with lower current density for long distance.

While the invention has been illustrated and described in detail in the drawings and foregoing description, such illustration and description are to be considered illustrative or exemplary and not restrictive. The invention is not limited to the disclosed embodiments. The proposed current density adaptation concept can be applied to other types of optical wireless networks and with other types of access devices, modems and transceivers. In particular, the invention is not limited to LiFi-related environments, such as the ITU-T G.9961, ITU-T G.9960, and ITU-T G.9991 network environment. It can be used in visible light communication (VLC) systems, IR data transmission systems, G.vlc systems, OFDM-based systems, connected lighting systems, OWC systems, and smart lighting systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described procedures like those indicated in FIG. 7 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for driving a semiconductor radiation source having a radiation generating area of a controllable size, the apparatus comprising:
a controller configured to adaptively control the size of the radiation generating area, to thereby change a current density and/or optical output power of the semiconductor radiation source;
a modulator configured to modulate a driving signal based on input data and supplying the modulated driving signal to the semiconductor radiation source to modulate a current flowing through the radiation source to optically transmit the input data; and
the controller configured to adaptively control the size of the radiation generating area independent from both the input data and the current flowing through the radiation source, to thereby change the current density and/or the optical output power of the semiconductor radiation source in response to at least one of a link performance requirement, a measured link quality and a distance to a receiver device.

2. The apparatus of claim 1, wherein the controller is configured to control the size of the radiation generating area by selecting a subset out of multiple light emitting diodes, LEDs, of the radiation source.

3. The apparatus of claim 2, wherein the controller is configured to control the size of the radiation generating area by causing a switch between using either one or two LEDs of the radiation source.

4. The apparatus of claim 2, wherein the LEDs of the radiation source are of the same type and the controller is configured to control transmission from the radiation source so that data packets are alternatingly transmitted via a different LED.

5. The apparatus of claim 1, wherein the controller is configured to control the current flowing through the radiation source as a separate parameter.

6. The apparatus of claim 1, wherein the controller is configured to operate the radiation source at a selected current density and to switch between different operating modes of the radiation source.

7. The apparatus of claim 1, wherein the controller is configured to control the current density of the radiation source and at least one modulation parameter of the modulator to achieve a trade-off between a degree to which transmission link is limited by noise and a degree to which the transmission link is limited by bandwidth.

8. The apparatus of claim 1, wherein the controller is configured to select among a fast operating mode of the radiation source with two active LEDs for short distance, a medium operation mode of the radiation source with one active LED with higher current density, and a slow operating mode of the radiation source with one active LED with lower current density for long distance.

9. The apparatus of claim 1, wherein the modulator is configured to modulate the driving signal supplied to the radiation source with a binary data sequence based on the input data to generate at least two levels of a driving current through the radiation source that define a first radiation output range of the radiation source between an upper radiation output level and a lower radiation output level during transmission of the binary data sequence, and wherein the controller is configured to adaptively control the modulator to increase the driving current and switch the increased driving current at a timing determined by a second radiation output range between a predetermined upper target radiation output level and a predetermined lower target radiation output level in response to a transmission quality of the radiation output, wherein the second radiation output range is reduced relative to the first radiation output range.

10. The apparatus of claim 1, further comprising a look-up table that stores a table of modulation parameters and current-density determining parameters associated with different channel attenuation conditions.

11. An optical wireless communication device for generating a radiation signal in an optical communication system, wherein the optical wireless communication device comprises an apparatus as claimed in claim 1 and a semiconductor radiation source having a radiation generating area of a controllable size.

12. An optical communication system comprising an optical wireless communication device as claimed in claim 11 and a receiver for receiving the radiation signal, wherein the receiver is configured to provide feedback information via a feedback channel to inform the controller about a link quality, or to command the controller via the feedback channel using the feedback information to change its current density setting.

13. A method of driving a semiconductor radiation source having a radiation generating area of a controllable size, the method comprising:
adaptively controlling the size of the radiation generating area, to thereby change a current density and/or output power of the semiconductor radiation source;
modulating a driving signal based on input data; and
supplying the modulated driving signal to the semiconductor radiation source to modulate a current flowing through the radiation source to optically transmit the input data;
wherein the adaptively controlling the size of the radiation generating area is independent from both the input data and from the current flowing through the radiation source, to thereby change the current density and/or the output power of the semiconductor radiation source in response to at least one of link performance requirement, measured link quality and distance to a receiver device.

14. The method of claim 13, further comprising selecting among a fast operating mode of the radiation source with two active LEDs for short distance, a medium operation mode of the radiation source with one active LED with higher current density, and a slow operating mode of the radiation source with one active LED with lower current density for long distance.

15. A non-transitory computer readable medium comprising instructions, the instructions when executed by a controller of an apparatus cause the controller to perform the method of claim 13.
